(19) United States
(12) Patent Application Publication
(10) Pub. No.: US 2011/0284696 A1
(43) Pub. Date: Nov. 24, 2011

(54) Control column system

(75) Inventors: MATTHIAS STIEFENHOFER, Lindenberg (DE); MATTHIAS LUDWIG, Lindenberg (DE); MICHAEL ROTTACH, Sulzberg (DE); RALPH NEUMANN, Scheldegg (DE); MANFRED SCHLOSSER, Lindenberg (DE)

(73) Assignee: Liebherr-Aerospace Lindenberg GmbH, Lindenberg (DE)

(21) Appl. No.: 12/816,654

(22) Filed: Jun. 16, 2010

(30) Foreign Application Priority Data
May 20, 2010 (DE) 102010022200.3

(51) Int. Cl. B64C 13/46; B64C 13/18; B64C 13/12

(52) U.S. Cl. 244/223

(57) ABSTRACT

The present invention relates to an active control column system for controlling an aircraft, comprising a control member architecture and a control architecture, wherein the control member architecture has at least one mechanically movable control column, at least one actuator for controlling the control column and at least one detection means for detecting at least one state variable of the control column, and the control architecture includes at least one movement regulator for controlling at least one actuator, a feeling generation means for generating at least one desired movement parameter, wherein the feeling generation means is indirectly/directly connected to at least one movement regulator and the generated desired parameter can be supplied to the movement regulator, and wherein at least one detection means is indirectly or directly connected to the feeling generation means for the supply of at least one state variable.

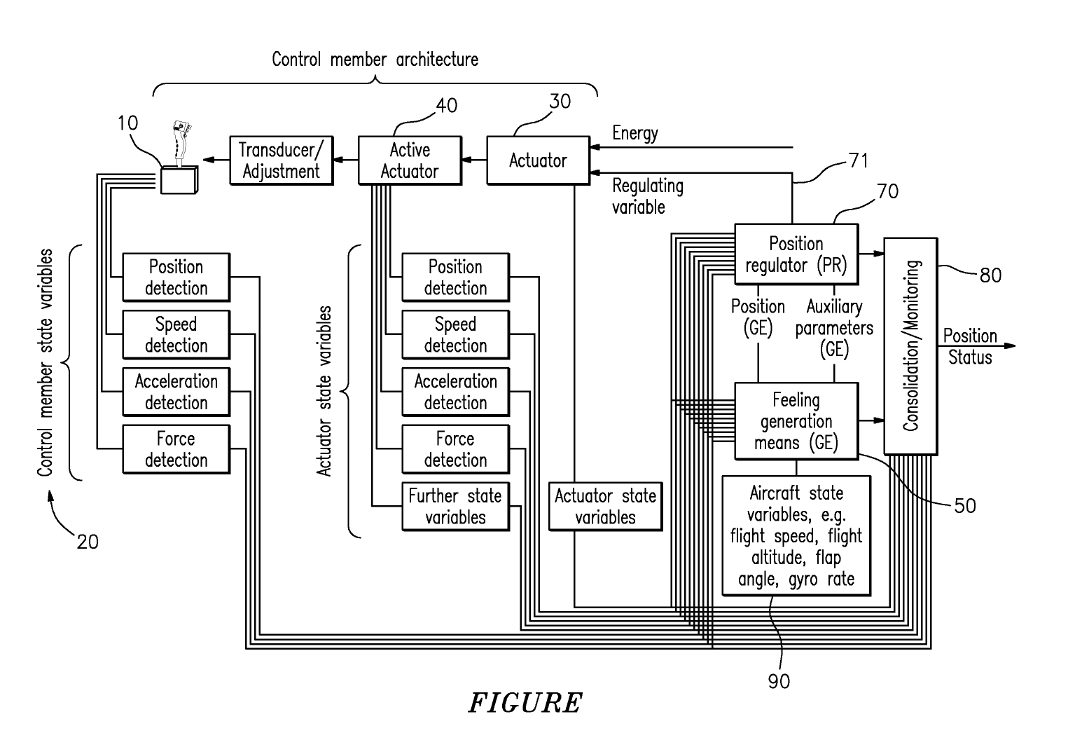

The present invention relates to an active control column system for the control of an aircraft, wherein an electrically simulated feeling can be generated for the operator of the aircraft at the mechanically movable control column.

Such control column systems as a rule use a mechanical control column which is movable about a plurality of axes and which can be actuated by the pilot for the flight control of an aircraft. The inclination of the control column about one of the axes, for example, influences the pitch attitude and/or bank attitude of an aircraft or the pitch and roll movement as well as the vertical movement of a helicopter. Unlike the classical control in which the control movements of the pilot are transmitted to the controlling operating apparatus of the aircraft by steel wires, connecting rods or other hydraulic systems, the changeable operating position of the mechanically movable control column is detected by an associated sensor system and is transmitted to the corresponding operating apparatus of the aircraft via electrical cables.

In a classical control column design, the forces acting on the aircraft during the flight are transmitted to the control unit in the form of resistance and amplitude. This feedback is omitted in the design of the fly-by-wire system with a passive control column system. The haptic information transmission of the control system is in particular frequently of great advantage for the pilot in aeronautical engineering.

Active control systems enable the simulation of the control forces which occur and adapt them to the respective flight situation in order thus to achieve an ideal assistance for the pilot. The feedback is transmitted to the control apparatus, for example, in the form of movements or signals, whereby an intuitive reaction of the pilot to the respective flight situation is facilitated. The pilot is furthermore given precise feedback on the control inputs he has carried out. The pilot therefore has the possibility of feeling the behavior of the aircraft during flight operation even on the use of an electrical control system.

Today's aircraft have a double control system for the pilot and co-pilot. In this case, it is meaningful that a connection or coupling is present between the two control systems. This coupling synchronizes both control apparatus so that the other pilot is aware of the control inputs of the other at all times and to avoid mutual conflicts of the control apparatus.

It is the object of the present invention to disclose a control column system for aircraft which realizes a generation of feeling on the control column triggered by control inputs.

This object is achieved by an active control column system in accordance with the features of claim 1. Further advantageous embodiments of the control column system are the subject of the subordinate claims dependent on the main claim.

An active control column system for the control of an aircraft accordingly has a control member architecture and a control architecture. The control member architecture substantially comprises a mechanically movable control column which is designed as freely movable about any desired number of axes and which serves for the control command input of the pilot. The integration of the control column is based on the known steer-by-wire technology which provides a forwarding of the control inputs of the pilot detected by means of the control column sensor system by signal cables to the corresponding operating members of the aircraft. The respective embodiments of the control column can be selected as desired, but will not be described in any more detail in the further text.

The architecture in accordance with the invention substantially relates to the generation of feeling by means of the feeling generation means and to the control which is superimposed on the actuated control column. For this purpose, the control member architecture includes at least one detection means for the detection of at least one state variable of the control column. The detection means can be a component of the aforesaid sensor system of an electrical control column or can be arranged as a separate means. The detection means in particular serves the detection of at least one movement state variable of the control column. A movement state variable is characterized, for example, by the then current control column position.

Advantageously, the speed and/or the acceleration at which the control column is actuated is/are likewise detected. The control member architecture likewise includes at least one actuator for the mechanical actuation of the control column. The actuator is preferably made as an electrical actuator, in particular as an electric motor or the like whose drive shaft is connected indirectly or directly to the control column via a transmission arrangement. At least one actuator can in particular be provided for each movement axis of the control column. The generation of feeling in accordance with the invention can preferably be applied to each axis of a control column made as a sidestick.

In accordance with the invention, the active control column system furthermore includes a control architecture which realizes an electronic force feedback for the generation of feeling. The control architecture includes at least one movement regulator which generates corresponding control signals in dependence on a desired movement parameter to adjust the existing state variable. The output of the movement regulator is in indirect or direct contact with at least one actuator of the control member architecture to supply the control signals generated to at least one actuator. A feeling generation means is furthermore provided which generates at least one desired movement parameter on the basis of at least one movement state variable. For this purpose, the feeling generation means is indirectly or directly connected to at least one detection means of the control member architecture, whereby at least one state variable of the detection means can be supplied to the feeling generation means.

The output of the feeling generation means is indirectly or directly connected to at least one movement regulator, whereby the generated desired movement parameter can be supplied to at least one movement regulator. Movement regulation is understood as the regulation of the pose, speed, acceleration or a combination thereof. The generation of a desired movement parameter by the feeling generation means and the corresponding regulation by movement regulators and the actuator provides a generation of feeling close to reality at the mechanically movable control column.

In a particularly advantageous embodiment of the invention, at least one movement regulation is made as a position regulator. The position regulator can be realized as desired, e.g., in the form of a cascade regulation, a state regulation or a PID regulation. On the use of a position regulator, the feeling generation means has to generate a desired position which is supplied indirectly or directly to the input of the position regulator. If the mechanically movable control column is actuated by the pilot, the feeling generation means generates a desired position, whereby the position regulator generates an active movement on the control column. The pilot is given direct feedback to the control input he has made by a simulated, tangible mechanical force feedback such as occurs with conventional mechanical control apparatus.

Alternatively or additionally, at least one movement regulator can be made as a speed regulator. In this case, the feeling generation means must additionally or alternatively generate at least a desired speed which is made available indirectly or directly to the speed regulator. Further advantageously, at least one movement regulator can be made as an acceleration regulator. At least one desired acceleration has to be generated by the feeling generation means to control the acceleration regulator.

The feeling generation means can be influenced by internal and/or external state variables. The internal state variables include the state variables of the control member architecture detected by at least one detection means. To make the generation of feeling more precise and to further sensitize it, additional state variables supplied from outside can be taken into account. These advantageously include on the use of the active control column system in an aircraft, the air speed, the altitude and the measured data of a gyroscope or any further data characterizing the flight operation.

Further advantageously, the signals of an autopilot can likewise be applied to the generation of feeling of the feeling generation means. The active control column system is consequently controllable by the autopilot.

It is conceivable that the state variables used in the feeling generation means are measured by one or more detection means or are alternatively mathematically determined or derived from one or more detected state variables within the feeling generation means. The number of required detection means can accordingly be reduced. For example, the total control column system can be realized with only one measured and/or derived state variable. The quality of the actively haptic control member can be improved by the addition of further state variables.

At least one force regulator can furthermore be provided which acts on the control member architecture in a manner assisting the movement regulation.

At least one detection means serves the determination of the then current operational position or position of the control column. Additionally or alternatively, at least one detections means is provided for the measurement of the then current speed and/or the then current acceleration and/or the then current force and/or a further state variable which the mechanically movable control column experiences on actuation.

The feeling generation means preferably generates the corresponding desired parameter for controlling the movement regulator used while using a characteristic and/or a spring-mass damping model of any order and magnitude and while taking account of at least one supplied state variable. The feeling generation means advantageously serves the realization of various feeling characteristics in the active control column system. This preferably includes, inter alia, the realization of any desired force position characteristic and/or any desired damping speed characteristic and/or a detend and/or a breakout and/or a position limitation and/or a soft stop and/or a friction model and/or a force offset and/or a position offset and/or a stick shaker and/or a speed restriction and/or a force restriction.

It is desirable for the realization of a parallel operation of at least two mechanically movable control columns that they can be coupled to one another. Against this background, the control column system in an advantageous embodiment includes at least two control columns and one or more control architectures which can be coupled with one another. For example, the desired parameter generated by at least one feeling generation means can be synchronously used on both mechanically movable control columns. The coupling mechanism can furthermore have further functional mechanisms to avoid the conflict situations which occur.

The control column system advantageously includes at least one monitoring means and/or consolidation means. The generated or detected states or desired parameters can accordingly be subjected to a plausibility check. Possible malfunctions or irregularities are recognized at an early time and are automatically remedied under certain circumstances. The corresponding results are advantageously storable as status reports and/or can be output via one or more optical and/or acoustic display means.

The mechanically movable control column is not limited to a predefined number of degrees of freedom. To assign a generation of feeling to every axis of movement of the control column, at least one regulator architecture is provided per axis.

Further advantages and particulars of the invention will be explained in detail with reference to an embodiment shown in the drawing.

The only FIGURE shows a block diagram of the active control column system in accordance with the invention. The control member architecture includes the mechanically movable control column 10 which is physically connected to at least one actuator 30. The actuator 30 is preferably made as an electric motor whose drive shaft effects a mechanical force on the control column 10 via a transmission structure and which generates a control column movement. Since the control column 10 is freely movable about any desired number of axes, one actuator 30 is provided per axis.

The architecture furthermore includes detection means 20 which are arranged at the column mechanics and serve the determination of the then current operating position of the control column 10. Further parameters, such as the speed, acceleration and force, which occur on an actuation of the control column 10, are likewise determined by further determination means 20. A further sensor system 40 determines the then current state variables of the actuators 40 used for the movement of the control column 10.

The feeling generation means 50 serves the generation of the electronically regulated feedback in dependence on the control column actuation. The signals of the internal state variables generated by the sensors 20, 40 are applied to the input of the feeling generation means 50. The position regulator 70 furthermore makes use of the said signal lines of the sensors 20, 40.

External state variables 90 are furthermore detected by external sensor systems and forwarded to the feeling generation means 50 to take account of the then current flight attitude of the aircraft. The then current air speed, the flight altitude, the set flap angle and the measured data of the gyroscopes used in the aircraft and corresponding signals of the autopilot are among the external state variables, for example.

The feeling generation means 50 generates a desired position for the control column 10 from the supplied state variables of the sensors 20, 40 and from the external state variables 90. The desired position can be generated using a stored characteristic or a feeling model with which different behavior characteristics can be associated. The use of a spring/mass model or of any desire force/position characteristic, which determines a predefined desired position for the control column 10 in dependence on an associated force state parameter, are named by way of example. Further embodiments use a damping speed characteristic or simulate detend and/or breakout and/or position restriction characteristics and/or soft stop characteristics and/or a friction model and/or a force or position offset and/or a force and/or speed limitation.

The state variables of the control member 10 and of the actuator 40 are applied to the actual input of the position regulator 70. A corresponding operating parameter 71 for the actuators 30 of the control member architecture is generated while taking account of the desired position generated by the feeling generation means and of the additional auxiliary parameters derived or determined from measured state variables. The operating parameter 71 e.g. includes any desired control voltages, control currents and any other control parameters for the motor or actuator control.

For technical safety reasons, the control column system includes a consolidation or monitoring means 80 which monitors the generated parameters of the position regulator 70 and of the feeling generation means 50 and optionally subjects them to a plausibility check. The respective data of the monitoring or consolidation means 50 are optionally output acoustically via a display element or are output optically as a status report.

The generation of feeling at the mechanically movable control column 10 can be generated easily using position regulation. The state variable force can furthermore be replaced by a state variable torque.

Since an aircraft is frequently equipped with a plurality of control column systems for reasons of redundancy, a coupling has to take place between the systems used. The communication between both systems is realized by means of an electrical connection. Inter alia, status reports of the monitoring or consolidation means or the used state variables of the actuators and the control columns are interchanged between the control architectures of the coupled systems.

Alternatively, a plurality of control columns or of control column systems are not used for redundancy reasons, but rather for the realization of various control tasks. A sidestick, for example, serves for the carrying out of roll and pitch movements of a helicopter, while a second sidestick controls the vertical movement. A synchronized generation of feeling on both sticks and the interchange of various status reports and state variables is also absolutely necessary here.
1 Control member architecture
2 Transducer/Adjustment
3 Active actuator
4 Actuator
5 Energy
6 Regulating variable
7 Position detection
8 Speed detection
9 Acceleration detection
10 Force detection
11 Control member state variables
12 Actuator state variables
13 Position detection
14 Speed detection
15 Acceleration detection
16 Force detection
17 Further state variables
18 Actuator state variables
19 Position regulator (PR)
20 Position GE
21 Auxiliary parameters (GE)
22 Feeling generation means (GE)
23 Aircraft state variables, e.g. flight speed, flight altitude, flap angle, gyro rate
24 Consolidation/Monitoring
25 Position Status

1. An active control column system for controlling an aircraft having a control member architecture and a control architecture for the generation of feeling for the operator of the aircraft, wherein the control member architecture comprises:
at least one mechanically movable control column;
at least one actuator for controlling the control column; and
at least one detection means for detecting at least one state variable of the control column, in particular for detecting at least one movement state variable,
the control architecture comprises:
at least one movement regulator for controlling at least one actuator; and
a feeling generation means for generating at least one movement parameter,
the feeling generation means is indirectly or directly connected to at least one movement regulator and the generated desired parameter can be supplied to the movement regulator; and at least one detection means is indirectly or directly connected to the feeling generation means for the supply of at least one state variable.

2. A control column system in accordance with claim 1, wherein at least one movement regulator is a position regulator.

3. A control column system in accordance with claim 1, wherein at one movement regulator is a speed regulator.

4. A control column system in accordance with claim 1, wherein at least one movement regulator is an acceleration regulator.

5. A control column system in accordance with claim 1, wherein internal and/or external state variables, in particular signals from an autopilot, can be supplied to the feeling generation means.

6. A control column system in accordance with claim 1, wherein the feeling generation means is made such that a desired position and/or a desired speed and/or a desired acceleration can be generated.

7. A control column system in accordance with claim 1, wherein at least one force regulator and/or torque regulator is/are provided.

8. A control column system in accordance with claim 1, wherein the control column system includes at least two control columns and one or more control architectures which can be coupled to one another.

9. A control column system in accordance with claim 1, wherein a monitoring and/or consolidation means is provided.

10. A control column system in accordance with claim 1, wherein the control column has any desired number of degrees of freedom which can at least partly be regulated by the corresponding regulator architecture.

11. A control column system in accordance with claim 2, wherein at least one movement regulator is a speed regulator.

12. A control column system in accordance with claim 11, wherein at least one movement regulator is an acceleration regulator.

13. A control column system in accordance with claim 3, wherein at least one movement regulator is an acceleration regulator.

14. A control column system in accordance with claim 2, wherein at least one movement regulator is an acceleration regulator.

15. A control column system in accordance with claim 14, wherein internal and/or external state variables, in particular signals from an autopilot, can be supplied to the feeling generation means.

16. A control column system in accordance with claim 13, wherein internal and/or external state variables, in particular signals from an autopilot, can be supplied to the feeling generation means.

17. A control column system in accordance with claim 12, wherein internal and/or external state variables, in particular signals from an autopilot, can be supplied to the feeling generation means.

18. A control column system in accordance with claim 11, wherein internal and/or external state variables, in particular signals from an autopilot, can be supplied to the feeling generation means.

19. A control column system in accordance with claim 4, wherein internal and/or external state variables, in particular signals from an autopilot, can be supplied to the feeling generation means.

20. A control column system in accordance with claim 3, wherein internal and/or external state variables, in particular signals from an autopilot, can be supplied to the feeling generation means.
